(19) United States
(12) Patent Application Publication
(10) Pub. No.: US 2022/0378555 A1
(43) Pub. Date: Dec. 1, 2022

(54) All-Zirconium One-piece Dental Implant

(71) Applicant: Yao-Tsung Wu, Chiayi City (TW)

(72) Inventor: Yao-Tsung Wu, Chiayi City (TW)

(21) Appl. No.: 17/336,277

(22) Filed: Jun. 1, 2021

(51) Int. Cl. A61C 8/00; A61C 13/107; A61C 9/00; A61C 13/00

(52) U.S. Cl. CPC A61C 8/0051; A61C 8/0012; A61C 8/0095; A61C 13/0001; A61C 9/0053; A61C 13/0004

(57) ABSTRACT

A method of making an all-zirconium one-piece dental implant has: oral scanning after implantation of artificial tooth roots, 3D archiving, making temporary dentures, and making integrated permanent dentures. The oral scanning is executed by an optical scanner and generates a digital file of a denture model, a five-axis processing machine makes a temporary denture according to the digital file of the denture model to provide fitting information to modify the digital file of the denture model or make a permanent denture. Making the permanent denture with an all-zirconium material without metal support comprises the five-axis processing machine forming a through hole in the permanent denture.

### BACKGROUND of INVENTION

### 1. Field of Invention

The present invention relates to dental implants, and more particularly to an all-zirconium one-piece dental implant.

### 2. Description of the Related Art

For the dental implant implementation, after the damaged tooth of the patient is extracted, a metal implant is implanted as an artificial tooth root, and then a transfer anchor tooth is set on the implant, and then a transfer mold with silicone such like material is employed to provides the patient's intraoral situation and the occlusion of the upper and lower jaw teeth. The dentition state of the patient's dentition area is obtained on the transfer mold, and then the cast is poured into the mold to produce an oral plaster model used to make a temporary braces on the oral plaster model, and the fitting conditions are modified after try-on for the production of the final denture.

However, the existing method uses transfer molds to obtain the shape of the dentition in the edentulous area of patient and then uses the plaster cast to make the oral plaster model, which is quite complicated and prone to errors. Therefore, the dentist has to spend a long time to do intraoral modeling process and modify adjustments, which often results in a longer diagnosis and treatment time, and relatively makes the patient feel uncomfortable. Furthermore, the dentures 84 made by the dental plaster model reproduced by the transfer mold are not only easy to have errors during the production, but also the process is cumbersome and time-consuming and lacks efficiency. In addition, the smell of the material in the transfer mold often makes patients feel uncomfortable. Also, the silicone and other materials for the transfer mold cause environmental pollution when discarded.

Furthermore, the traditional denture 84 is attached with a metal support 85 inside, and the metal support 85 is combined with the implant root 80 and fastened by a bolt 86. However, the oral plaster model 82 might have errors, with the difference in physical properties between the metal support 85 and the denture 84, the adhesion between metal support 85 and the denture 84 can be affected. On the other hand, if the traditional denture 84 needs to be colored or porcelainized, the steps of adhesion and polishing need to be repeated, the process is complicated and inefficient, which are time-consuming and laborious. In addition, the denture 84 is fixed with the metal support 85, due to the color difference between the denture 84 and the metal support 85, the metal support 85 can be clearly seen between the bottom of the denture 84 and the gum, which greatly reduces the aesthetics of the denture installation.

Therefore, it is desirable to provide an all-zirconium one-piece dental implant to mitigate and/or obviate the aforementioned problems.

### SUMMARY OF THE INVENTION

An objective of present invention is to provide an all-zirconium one-piece dental implant.

To achieve these and other objects of the present invention, a method of making an all-zirconium one-piece dental implant has: oral scanning after implantation of artificial tooth roots, 3D archiving, making temporary dentures, and making integrated permanent dentures. The oral scanning is executed by an optical scanner and generates a digital file of a denture model, a five-axis processing machine makes a temporary denture according to the digital file of the denture model to provide fitting information to modify the digital file of the denture model or make a permanent denture. Making the permanent denture with an all-zirconium material without metal support comprises the five-axis processing machine forming a through hole in the permanent denture.

Other objects, advantages, and novel features of invention will become more apparent from the following detailed description when taken in conjunction with the accompanying drawings.

### BRIEF DESCRIPTION OF DRAWINGS

FIG. 1 is a flow chart of the method of making dental implants according to the present invention.

FIG. 2 is a schematic drawing of assembling the dental implant according to the present invention.

FIG. 3 is a cross-sectional view of the dental implant and the implant root according to the present invention.

FIG. 4 is a schematic diagram of the permanent denture being implanted in the implant root in a row according to the present invention.

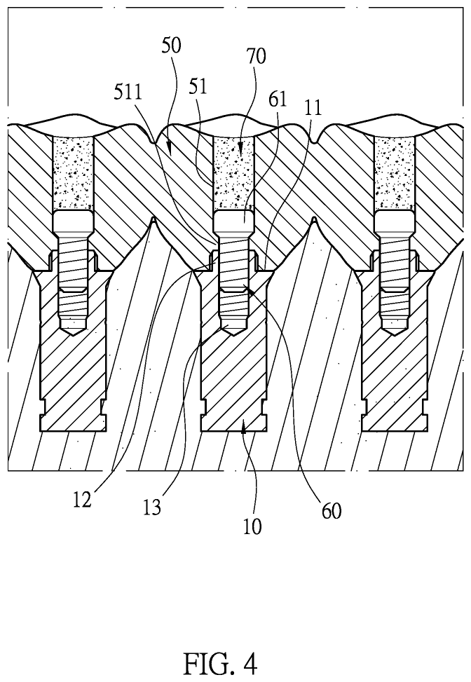

FIG. 5 is a flow chart of the traditional implant denture.

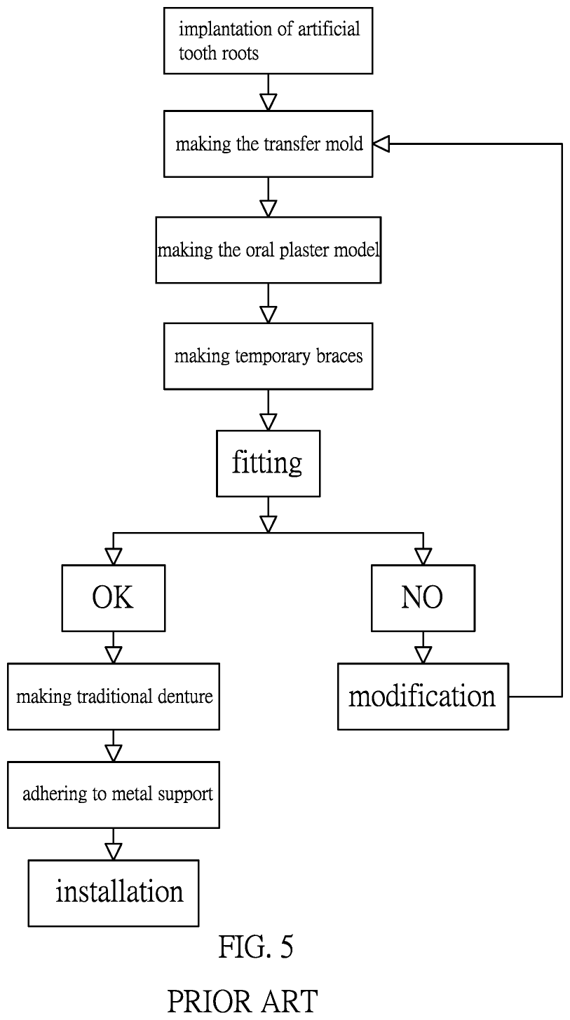

FIG. 6 is a schematic drawing of the traditional implant denture.

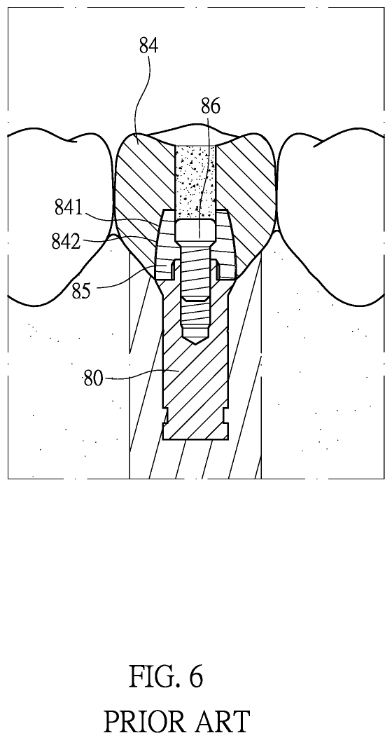

### DETAILED DESCRIPTION OF THE PREFERRED EMBODIMENT

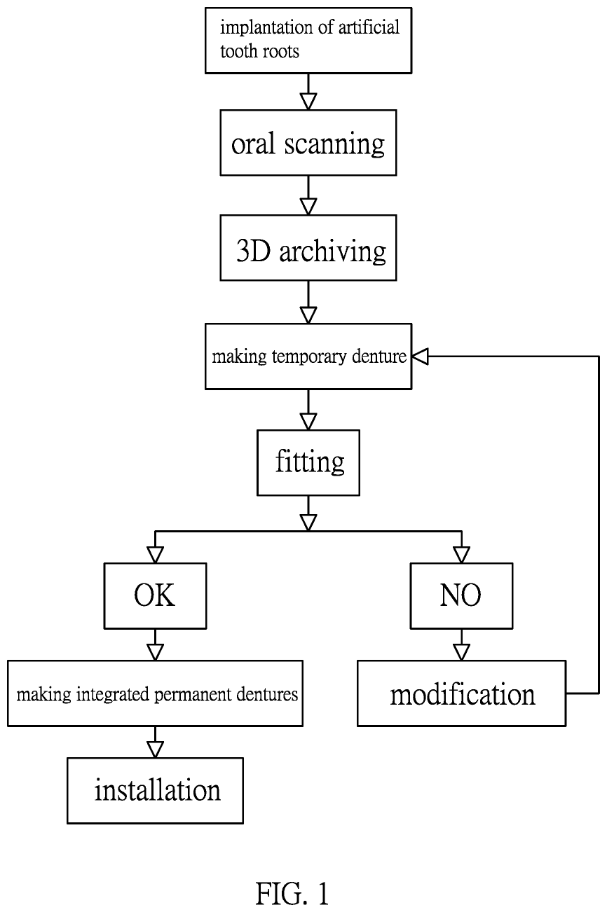

First, please refer to FIG. 1. A method of making an all-zirconium one-piece dental implant comprises: oral scanning after implantation of artificial tooth roots 10, 3D archiving, making temporary dentures, and making integrated permanent dentures 50. The oral scanning is executed by an optical scanner and generates a digital file of a denture model with CAD/CAM software. A five-axis processing machine makes a temporary denture with resin material according to the digital file of the denture model to provide fitting information to modify the digital file of the denture model or make a permanent denture 50. While making the permanent denture 50 with an all-zirconium material without metal support, the five-axis processing machine forming an engaging through hole 51 in the permanent denture 50.

Finally, by changing the color or adding porcelain to complete the permanent denture 50.

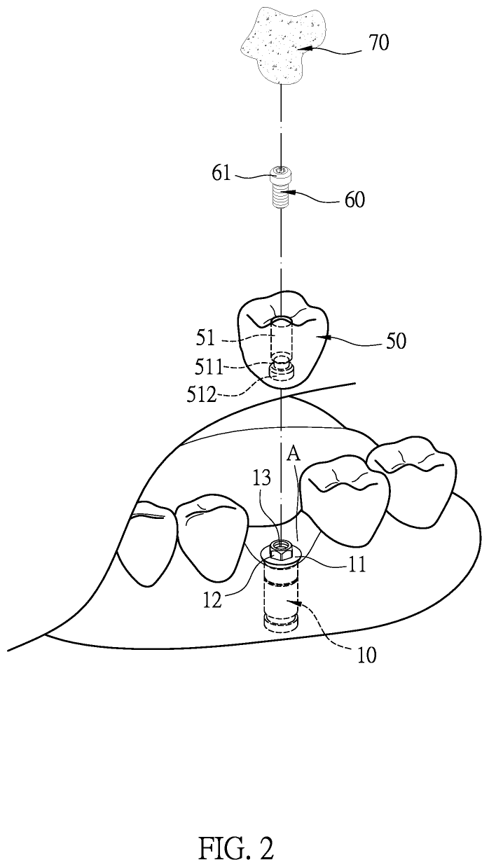

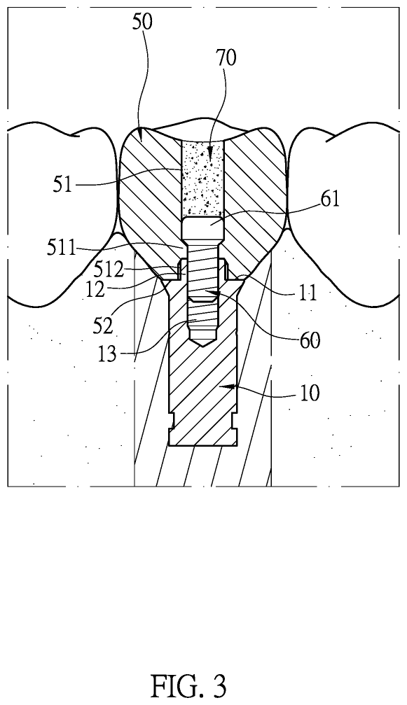

Please refer to FIG. 2 and FIG. 3. An all-zirconium one-piece dental implant comprises: an implant root 10, a permanent denture 50, an implant screw 60 and a filler 70. The implant root 10 is embedded in a patient's gum and has a top surface 11 and an engaging portion 12 protruding from the top surface 11. The top surface 11 and the engaging portion 12 are exposed from the gum A, and the engaging portion is connected to a mounting screw hole. The permanent denture 50 is composed of an all-zirconium material processed by a five-axis processing machine and comprises the contact surface and an engaging through hole 51. The engaging through hole 51 further has a positioning ring 511 corresponding to a height of the engaging portion 12, and the positioning ring 511 has a crown portion 512 configured for surrounding the engaging portion 12 and pushes against a top face of the engaging portion 12. The permanent denture 50 has a flat bottom 52 matching the top surface 11 of the implant root 10. The implant screw 60 is capable of engaging with the engaging through hole 51 and the mounting screw hole 13 of the implant root 10. The implant screw 60 further has a positioning end 61 pushing against the positioning ring 511. The filler 70 is added into the engaging through hole 51 from the contact surface of the permanent denture 50.

The engaging portion 12 of the implant root 10 is a hexagonal convex column or an octagonal convex column.

Furthermore, the permanent denture 50 is a single crown corresponding to one implant root. Alternatively, the permanent denture 50comprises multiple crowns for a full jaw, and the permanent denture 50 has at least two engaging through holes 51 corresponding to at least two implant roots 10.

With the structure of the above specific embodiment, the following benefits can be obtained: the present invention obtains digital file image data in the oral cavity by scanning the patient's oral cavity to design and construct a digital denture model in a computer for a physical production. Accordingly, the efficiency and accuracy of denture production can be improved with the computer, and an integrated process is performed immediately to obtain the permanent denture 50 simply and quickly, which effectively saves doctor's and patient's time, reduces the inaccuracy and human error, and avoids the discomfort for the patients and environmental problems.

Secondly, the digital file image data obtained by the oral scan and the 3D file can be saved permanently to avoid the storage problems caused by the paper data and physical molds and help improve work efficiency.

In addition, the permanent denture 50 of the present invention is made of integrated all-zirconium, so the permanent denture 50 has no metal support inside, which can reduce the error and inconvenience caused by traditional dentures adhering to the metal support. When the color or the porcelain on the surface of the permanent denture 50 needs to be modified, it can directly be processed which eliminates the need for traditional process. It greatly improves the efficiency of denture production, and the permanent denture 50 is designed with all zirconium metal-free pillars, and it also has an overall aesthetic.

Although the present invention has been explained in relation to its preferred embodiment, it is to be understood that many other possible modifications and variations can be made without departing from the spirit and scope of invention as hereinafter claimed.

What is claimed is:

1. A method of making an all-zirconium one-piece dental implant comprising: oral scanning after implantation of artificial tooth roots, 3D archiving, making temporary dentures, and making integrated permanent dentures; wherein the oral scanning is executed by an optical scanner and generates a digital file of a denture model, a five-axis processing machine makes a temporary denture according to the digital file of the denture model to provide fitting information to modify the digital file of the denture model or make a permanent denture, and wherein making the permanent denture with an all-zirconium material without metal support comprises the five-axis processing machine forming a through hole in the permanent denture.

2. An all-zirconium one-piece dental implant comprising: an implant root, a permanent denture, an implant screw and a filler; the implant root embedded in a patient's gum and having a top surface and an engaging portion protruding from the top surface, the top surface and the engaging portion exposed from the gum, the engaging portion connected to a mounting screw hole; the permanent denture composed of an all-zirconium material processed by a five-axis processing machine and comprising a contact surface and an engaging through hole, the engaging through hole further having a positioning ring corresponding to a height of the engaging portion, the positioning ring having a crown portion configured for surrounding the engaging portion and pushing against a top face of the engaging portion; the permanent denture having a flat bottom matching the top surface of the implant root; the implant screw capable of engaging with the engaging through hole and the mounting screw hole of the implant root;
the implant screw further having a positioning end pushing against the positioning ring, the filler being added into the engaging through hole from the contact surface of the permanent denture.

3. The all-zirconium one-piece dental implant as claimed in claim 2, wherein the permanent denture is a single crown corresponding to one implant root.

4. The all-zirconium one-piece dental implant as claimed in claim 2, wherein the permanent denture comprises multiple crowns for a full jaw, and the permanent denture has at least two engaging through holes corresponding to at least two implant roots.
